(19) United States
(12) Patent Application Publication
(10) Pub. No.: US 2012/0014741 A1
(43) Pub. Date: Jan. 19, 2012

(54) CUSHIONED SLIDING JOINT

(76) Inventor: Ignacio ZAMORA GÓMEZ, Villaviciosa de Odon (Madrid) (ES)

(21) Appl. No.: 13/156,409

(22) Filed: Jun. 9, 2011

(30) Foreign Application Priority Data
Jul. 7, 2010 (ES) P201031035

(51) Int. Cl. B64C 1/06; F16C 29/02

(52) U.S. Cl. 403/52

(57) ABSTRACT

A cushioned sliding joint designed to be used in two structural elements joint of one single pin where it is not desired an axial load transferring or it is necessary to restrict that transferring.

The restriction of the axial load transferring is achieved by incorporating elastic members between some of the components of the joint. The elastic members allow axial displacements but present higher resistance according to the magnitude of the movement.

### OBJECT OF THE INVENTION

The main object of the present invention is to provide a cushioned sliding joint that restricts or eliminates the axial load transferring.

A further object of the present invention is to provide a cushioned sliding joint that is able to absorb the assembly tolerances of the joint.

A further object of the invention is to provide a cushioned sliding joint to be employed for applications with requirements of displacement absorptions and rotation absorptions under harsh environmental conditions and wide ranges of pressure and temperature in areas with high probability of corrosion due to contaminants and unfavorable environments which could harm the performance of the joint.

A further object of the invention is to provide a cushioned sliding joint easily adaptable to already existent assemblies.

### FIELD OF THE INVENTION

The present invention falls within the joints of structural elements of one single pin or a failsafe pin where it is not desiderated an axial load transferring, where it is necessary to restrict that axial load transferring or where it is necessary to absorb the assembly tolerances of the joint.

The present invention is also used in applications with requirements of displacement absorptions and rotation absorptions under harsh environmental conditions and wide ranges of pressure and temperature in areas with high probability of corrosion due to contaminants and unfavorable environments.

Particularly the invention falls within the aeronautical industry where the typical areas of interest are the joints between moving elements of the aircraft, such as the doors of the landing gear, aerodynamic fairings, the flaps, rudders and other control surfaces of the aircraft, with permanent contact or during certain stages of the flight, with the exterior atmosphere.

### BACKGROUND OF THE INVENTION

The most employed solution of a single pin sliding joint known from the state of the art is a sliding joint based on a pin assembly joining a female and a male lug. In this kind of joints, the combination of washers, sliding bushings and shouldered bushings, as well as the choice of bolts of the suitable length allows relative axial displacements among the structurally joined components.

The first advantage of this kind of union is the capacity of absorption of the installation tolerances among the different elements to be joined.

The relative distances between the different joining elements of each component are subjected to variations due to their own installation tolerances. If all the joining elements were of the clamped type, because of the previous tolerances, undesirable assembly stresses would be produced. Due to that, in a non ideal case of positioning, it would be necessary to force the elements such that they would coincide with each other.

Said way of joining components requires the installation of all the elements in the right order and position (screws, nuts, washers, spherical bearings, etc.) as well as the application of a given tightening torque which is defined in the relevant legislation.

In the working conditions of this kind of joints known from the prior art, the load transferring among the different components cause deflections and relative movements among the elements of the joint that can result in undesirable contacts. The load transfer must be carried out between elements that are designed and calculated for that in order to avoid those undesirable contacts that will damage the joint.

In the design of the joints it has to be considered the maximum assembly tolerance, the maximum deflection and the value of the load at the plane of the joint itself.

This kind of union has important drawbacks. A first disadvantage appears in the joints with frequent relative sliding between the elements to be joined where the elements experiencing friction among them can suffer wear.

Another disadvantage of this kind of joint is that when the value of the addition of the assembly tolerances and the deflections at the joint are higher than those taken into account, undesirable contacts will be produced. As a consequence a load transfer is produced among elements that are not prepared for that and this can reduce the fatigue life or create problems of structural endurance.

To solve those problems, in the optimum cases it is enough to increase the design value of the amount of maximum assembly tolerance and maximum deflection.

The problem is that if the burden of forces action on the joint is high, increase the design value of the amount of maximum assembly tolerance and maximum deflection can cause the appearance of greater bending stresses at the pin that will force to use a pin with a bigger diameter. In these cases, the joint has to be completely designed again.

### DESCRIPTION OF THE INVENTION

The present invention is designed to overcome above-mentioned drawbacks of the sliding joints known from the prior art.

The present invention has the object of defining an intermediate solution between the sliding joints and the clamped joints.

The present cushioned sliding joint allows certain sliding but in a controlled manner, such that undesirable contacts in non-targeted areas of the pieces to be joined are avoided.

While in the clamped joints the lateral load is only reacted at one of the sides of the female lug, in the present cushioned sliding joint, the lateral load to be reacted is equally shared between the two parts of the female lug. This condition favors designs with less weight. This decreasing of the weight is especially important when working for the aeronautical industry.

An important advantage of the present cushioned sliding joint is that it does not cause any detriment to the resistance of the joint to the loads at the plane of the lug itself.

The present invention describes a cushioned sliding joint for a two structural elements joint, whereby the two structural elements joint comprises a first element having a female lug and a second element comprising a male lug. The joint further comprises a single pin or a failsafe pin, a nut, a spherical bearing placed in a hole on the male lug, at least one washer and at least one shouldered bushing. Said cushioned sliding joint is characterized in that the joint comprises at least one elastic member allows a displacement in a controlled manner due to its arrangement in the joint.

The displacement in a controlled manner is the result of the action of the elastic member. The combination of washers and bushings is calculated considering the space left in the joint and the elastic constant of the elastic member.

In one of the embodiments of the invention, the cushioned sliding joint is characterized in that the elastic member is arranged on a external side of the female lug between a shouldered bushing and a washer. Said shouldered bushing is arranged on a hole of the external side of the female lug and said washer is arranged in direct contact with the nut.

In another embodiment of the invention, the cushioned sliding joint is characterized in that the elastic member is arranged on a external side of the female lug between a shouldered bushing and a washer. Said shouldered bushing being arranged on a hole of the external side of the female lug and said washer is arranged in direct contact with the head of the pin.

In another embodiment of the invention, the joint comprises two elastic members. A first elastic member is arranged on a first external side of the female lug between a first shouldered bushing and a first washer. Said first shouldered bushing is arranged on a hole of the first external side of the female lug and said first washer is arranged in direct contact with the nut. A second elastic element is arranged on a second external side of the female lug between a second shouldered bushing and a second washer. Said second shouldered bushing is arranged on a hole of the second external side of the female lug and said second washer is arranged in direct contact with the head of the pin.

In another embodiment of the invention, the joint comprises at least an additional washer and at least an additional shouldered bushing. Said additional washer is arranged in direct contact with an interior side of the female lug. Said additional shouldered bushing is arranged between a washer arranged in direct contact with the nut and a spherical bearing arranged in a hole on the male lug. Said additional shouldered bushing is coaxial with the pin. The elastic member is arranged between the additional washer and the additional shouldered bushing.

In another embodiment of the invention, the joint comprises at least an additional washer and at least an additional shouldered bushing. Said additional washer is arranged in direct contact with an interior side of the female lug, said additional shouldered bushing is arranged between a washer arranged in direct contact with the head of the pin and a spherical bearing arranged in a hole on the male lug. Said additional shouldered bushing is coaxial with the pin. The elastic member is arranged between said additional washer and said additional shouldered bushing.

In another embodiment, of the present invention, the joint comprises two additional washers, two additional shouldered bushings and two elastic members. There is a first additional washer arranged beside a first interior side of the female lug. There is a first additional shouldered bushing arranged between a washer arranged in direct contact with the nut and a spherical bearing arranged in a hole on the male lug. The first additional shouldered bushing is coaxial with the pin. There is a second washer being arranged beside a second interior side of the female lug. There is a second additional shouldered bushing arranged between a washer arranged in direct contact with the head of the pin and the spherical bearing arranged in the hole on the male lug. Said additional second shouldered bushing is coaxial with the pin. There is a first elastic member arranged between the first additional washer and the first additional shouldered bushing and there is a second elastic member arranged between the second additional washer and the second additional shouldered bushing.

In the present invention the elastic members are selected among springs, elastomeric bands or elastomeric rings.

A big advantage of the present invention is that is easily adaptable to already existing assemblies.

### BRIEF DESCRIPTION OF THE DRAWINGS

The present invention will be entirely understood on the basis of the following detailed description of the embodiments of the present invention and the accompanying drawings that are presented, solely as an example and which are therefore not restrictive within the present invention, and in which:

FIG. 1 depicts a first embodiment of the invention. It is represented a cushioned sliding joint where the elastic members are springs and are placed exterior to the female lug.

FIG. 2 depicts another embodiment of the invention. It is represented a cushioned sliding joint where the elastic elements are springs and are placed between the female lug and the male lug.

FIG. 3 depicts another embodiment of the invention. It is represented a cushioned sliding joint where the elastic elements are elastic bands and are placed exterior to the female lug.

FIG. 4 depicts another embodiment of the invention. It is represented a cushioned sliding joint where the elastic elements are elastic bands and are placed between the female lug and the male lug.

### REFERENCES

1: pin
2: nut
3: female lug
4: male lug
5: first washer
6: spherical bearing
7: first shouldered bushing
8: second washer
9: spring
10: first sleeve bushing
11: second sleeve bushing
12: first additional shouldered bushing
13: second additional shouldered bushing
14: first additional washer
15: second additional washer
16: spring
17: spring
18: elastic band
19: elastic band
20: elastic band
21: elastic band
22: second shouldered bushing
23: spring

### DESCRIPTION OF A PREFERRED EMBODIMENT

The following description is provided for the benefit of the reader only, and is not intended to limit in any way the invention as set forth by the claims.

The invention consists on adding elements with elastic properties in the axial direction a joint of two structural elements of one single pin. Those elastic elements selected among springs, elastomeric bands or elastomeric rings.

The operation of the joint is of hybrid type since it would allow axial displacements, presenting higher resistance thereto according to the magnitude of the movement. Therefore, it appears, through the elastic elements added, an axial force which opposes increasingly to the axial movement.

The present cushioned sliding joint is designed to be used in a two structural elements joint where said two structural elements joint comprises a first element having a female lug (3) and a second element having a male lug (4). The joint further comprises the following elements, common to all the preferred embodiments of the invention:

a single pin (1) or a failsafe pin,

a nut (2),

a spherical bearing (6) placed in a hole on the male lug (4),

a first washer (5) placed in direct contact with the nut (2),

a second washer (8) placed in direct contact with the head of the pin (1),

a first shouldered bushing (7) placed in a first external side of the female lug (3),

a second shouldered bushing (22) placed in a second external side of the female lug (3).

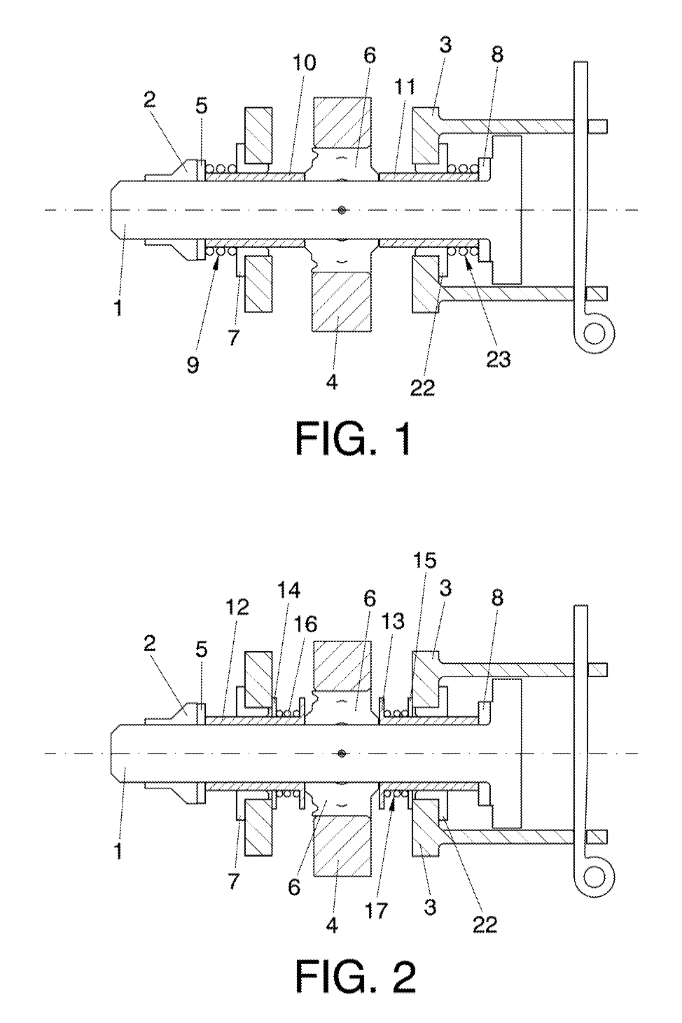

In a first embodiment of the invention showed in FIG. 1, additionally to the cited elements that are common to all the preferred embodiments of the invention, there are also two sleeve bushings (10, 11) placed in an axial direction of the joint and the elastic elements used to absorb the axial load transferring are springs (9,23).

In this first embodiment of the invention, a first sleeve bushing (10) is placed coaxial to the pin (1) and is arranged between the first washer (5) and the spherical bearing (6). A second sleeve bushing (11) is placed coaxial to the pin (1) and is arranged between the second washer (8) and the spherical bearing (6).

In this first embodiment, one of the springs (9) is arranged on a first external side of the female lug (3) between a shouldered bushing (7) and the first washer (5). Another spring (23) is arranged on a second external side of the female lug (3) between a shouldered bushing (22) and the second washer (8).

In a second embodiment of the invention showed in FIG. 2, additionally to the cited elements that are common to all the preferred embodiments of the invention, there are also two additional shouldered bushings (12,13), two additional washers (14,15) and the elastic elements used to absorb the axial load transferring are springs (16,17).

In this second embodiment, the first additional shouldered bushing (12) is placed coaxial to the pin (1) and is arranged between the first washer (5) and a spherical bearing (6). The second additional shouldered bushing (13) is placed coaxial to the pin (1) and is arranged between the second washer (8) and the spherical bearing (6).

In this second embodiment, the first additional washer (14) is arranged in direct contact with a first interior side of the female lug (3) and the second additional washer (15) is arranged in direct contact with a second interior side of the female lug (3).

In this second embodiment, the first spring (16) is arranged between the first additional washer (14) and the first additional shouldered bushing (12). The second spring (17) is arranged between the second additional washer (15) and the second additional shouldered bushing (13).

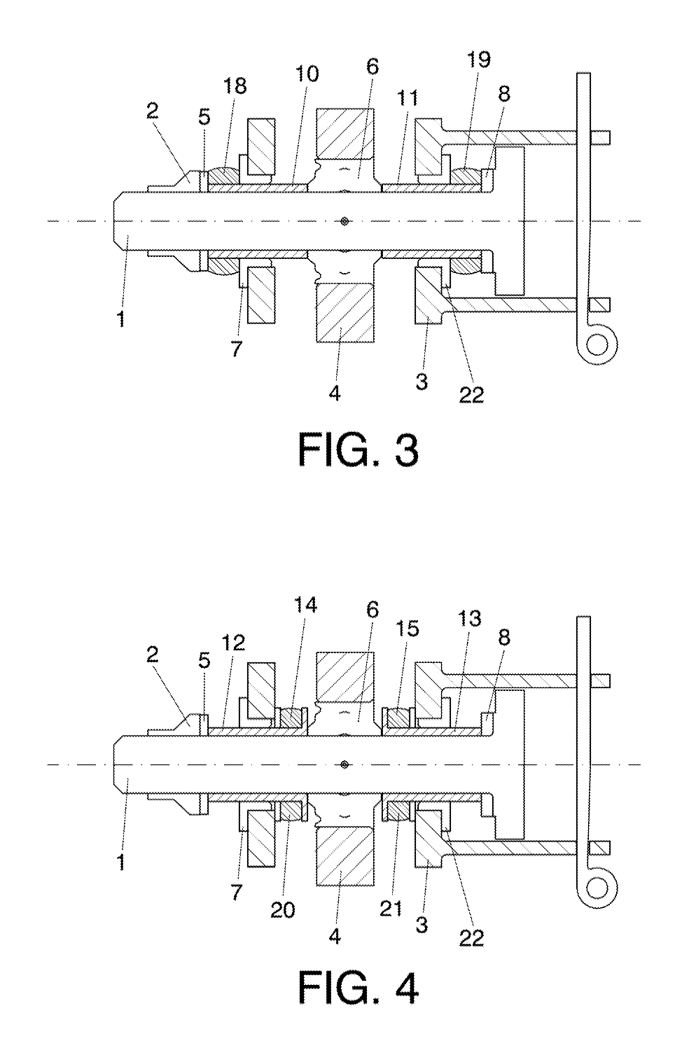

In FIG. 3 is shown a third embodiment of the present invention. This particular embodiment is similar to the first embodiment described above and represented in FIG. 1. The only difference is that the elastic elements used to absorb the axial load transferring are elastic bands (18, 19) instead of being springs (9, 23).

In FIG. 4 is shown a forth embodiment of the present invention. This particular embodiment is similar to the second embodiment described above and represented in FIG. 2. The only difference is that the elastic elements used to absorb the axial load transferring are elastic bands (20, 21) instead of being springs (16, 17).

1. CUSHIONED SLIDING JOINT for a two structural elements joint, whereby the two structural elements joint comprises a first element having a female lug (3) and a second element having a male lug (4); the joint further comprising a single pin (1) or a failsafe pin, a nut (2),a spherical bearing (6) placed in a hole on the male lug (4), at least one washer and at least one shouldered bushing characterized in that the joint comprises at least one elastic member allows a displacement in a controlled manner due to its arrangement in the joint.

2. CUSHIONED SLIDING JOINT, according to claim 1, characterized in that the elastic member is arranged on a external side of the female lug (3) between a shouldered bushing (7) and a washer (5), the shouldered bushing (7) being arranged on a hole of the external side of the female lug (3), the washer (5) being placed in direct contact with the nut (2).

3. CUSHIONED SLIDING JOINT, according to claim 1, characterized in that the elastic member is arranged on a external side of the female lug between a shouldered bushing (22) and a washer (8), the shouldered bushing (22) being arranged on a hole of the external side of the female lug (3), the washer (8) being arranged in direct contact with the head of the pin (1).

4. CUSHIONED SLIDING JOINT, according to claim 1, characterized in that the joint comprises two elastic members,
a first elastic member being arranged on a first external side of the female lug (3) between a first shouldered bushing (7) and a first washer (5), the first shouldered bushing (7) being arranged on a hole of the first external side of the female lug (3), the first washer (5) being arranged in direct contact with the nut (2),
a second elastic member being arranged on a second external side of the female lug (3) between a second shouldered bushing (22) and a second washer (8), the second shouldered bushing (22) being arranged on a hole of the second external side of the female lug (3), the second washer (8) being arranged in direct contact with the head of the pin (1).

5. CUSHIONED SLIDING JOINT, according to claim 1, characterized in that the joint comprises at least an additional washer (14) and at least an additional shouldered bushing (12),
the additional washer (14) being arranged beside an interior side of the female lug(3),
the additional shouldered bushing (12) being arranged between a washer (5) arranged in direct contact with the nut (2) and a spherical bearing (6) arranged in a hole on the male lug (4), and the additional shouldered bushing (12) being coaxial with the pin,
and the elastic member being arranged between the additional washer (14) and the additional shouldered bushing (12).

6. CUSHIONED SLIDING JOINT, according to claim 1, characterized in that the joint comprises at least an additional washer (15) and at least an additional shouldered bushing (13),
the additional washer (15) being arranged in direct contact with an interior side of the female lug (3),
the additional shouldered bushing (13) being arranged between a washer (8) arranged in direct contact with the head of the pin (1) and a spherical bearing (6) arranged in a hole on the male lug (4), and the additional shouldered bushing (13) being coaxial with the pin,
and the elastic member being arranged between the additional washer (15)and the additional shouldered bushing (13).

7. CUSHIONED SLIDING JOINT, according to claim 1, characterized in that the joint comprises two additional washers (14, 15), two additional shouldered bushings (12, 13) and two elastic members,
a first additional washer (14) being arranged in direct contact with a first interior side of the female lug (3),
a first additional shouldered bushing (12) being arranged between a washer (5) arranged in direct contact with the nut (2) and the spherical bearing (6) arranged in a hole on the male lug (4), and the first additional shouldered bushing being coaxial with the pin (1),
a second additional washer (15) being arranged in direct contact with a second interior side of the female lug (3),
a second additional shouldered bushing (13) being arranged between a washer (8) arranged in direct contact with the head of the pin (1) and a spherical bearing (6) arranged in a hole on the male lug (4), and the second additional shouldered bushing being coaxial with the pin (1),
a first elastic member being arranged between the first additional washer (14) and the first additional shouldered bushing (12),
and a second elastic member being arranged between the second additional washer (15) and the second additional shouldered bushing (13).

8. CUSHIONED SLIDING JOINT, according to claim 1, characterized in that the elastic members are selected among springs, elastomeric bands or elastomeric rings.

9. CUSHIONED SLIDING JOINT, according to claim 2, characterized in that the elastic members are selected among springs, elastomeric bands or elastomeric rings.

10. CUSHIONED SLIDING JOINT, according to claim 3, characterized in that the elastic members are selected among springs, elastomeric bands or elastomeric rings.

11. CUSHIONED SLIDING JOINT, according to claim 4, characterized in that the elastic members are selected among springs, elastomeric bands or elastomeric rings.

12. CUSHIONED SLIDING JOINT, according to claim 5, characterized in that the elastic members are selected among springs, elastomeric bands or elastomeric rings.

13. CUSHIONED SLIDING JOINT, according to claim 6, characterized in that the elastic members are selected among springs, elastomeric bands or elastomeric rings.

14. CUSHIONED SLIDING JOINT, according to claim 7, characterized in that the elastic members are selected among springs, elastomeric bands or elastomeric rings.
